(19) United States
(12) Patent Application Publication
(10) Pub. No.: US 2023/0303460 A1
(43) Pub. Date: Sep. 28, 2023

(54) METHOD OF MANUFACTURING Si-SiC-BASED COMPOSITE STRUCTURE

(71) Applicants: NGK Insulators, Ltd., Nagoya-City (JP); NGKADREC Company, Mitake Cho (JP)

(72) Inventors: Sora GOTO, Komaki-City (JP); Shuhei KUNO, Komaki-City (JP); Hiroomi MATSUBA, Mizunami-Shi (JP)

(73) Assignees: NGK Insulators, Ltd., Nagoya-City (JP); NGKADREC Company, Mitake Cho (JP)

(21) Appl. No.: 18/166,084

(22) Filed: Feb. 8, 2023

(30) Foreign Application Priority Data
Mar. 23, 2022 (JP) 2022-046476

(51) Int. Cl. C04B 41/50; C04B 35/565

(52) U.S. Cl. CPC C04B 41/5096; C04B 35/565; C04B 2235/3826; C04B 2235/428; C04B 2235/616; C04B 2235/94

(57) ABSTRACT

Provided is a method of manufacturing a Si-SiC-based composite structure capable of manufacturing a Si-SiC-based composite structure having a desired shape while suppressing the deformation of a molded body. The method of manufacturing a Si-SiC-based composite structure includes a step of impregnating a molten metal containing Si into a molded body containing SiC by heating a supply body containing Si under a state in which the molded body is in contact with a deformation suppressing member configured to suppress deformation of the molded body and in which the supply body is in contact with the molded body.

### BACKGROUND OF THE INVENTION

This application claims priority under 35 U.S.C. Section 119 to Japanese Patent Application No. 2022-046476 filed on Mar. 23, 2022 which is herein incorporated by reference.

### 1. FIELD OF THE INVENTION

The present invention relates to a method of manufacturing a Si-SiC-based composite structure.

### 2. DESCRIPTION OF THE RELATED ART

A Si-SiC-based composite material has excellent thermal conductivity and is expected to be used in various industrial products. As a method of manufacturing a structure formed of such Si-SiC-based composite material (hereinafter referred to as “Si-SiC-based composite structure”), there has been proposed, for example, a technology of impregnating a molten metal containing Si into a body to be impregnated, by heating an impregnation metal supply body containing Si to 1,200° C. or more and 1,600° C. or less under a state in which the impregnation metal supply body containing Si is in contact with a SiC-containing body to be impregnated (see WO2011/145387).

It is desired that such Si-SiC-based composite structure be manufactured in an appropriate shape depending on the application. The shape of the Si-SiC-based composite structure depends on the shape of a body to be impregnated, and hence bodies to be impregnated having various shapes are heated as described above under a state of being in contact with the impregnation metal supply body. Then, due to the own weight of the body to be impregnated and/or the load from the impregnation metal supply body, the body to be impregnated is deformed, with the result that a Si-SiC-based composite structure having a desired shape may not be manufactured.

### SUMMARY OF THE INVENTION

The main object of the present invention is to provide a method of manufacturing a Si-SiC-based composite structure capable of manufacturing a Si-SiC-based composite structure having a desired shape while suppressing the deformation of a molded body.

According to at least one embodiment of the present invention, there is provided a method of manufacturing a Si-SiC-based composite structure, including a step of impregnating a molten metal containing Si into a molded body containing SiC by heating a supply body containing Si under a state in which the molded body is in contact with a deformation suppressing member configured to suppress deformation of the molded body and in which the supply body is in contact with the molded body.

In one embodiment, the deformation suppressing member is a cradle having a support surface along an outer shape of the molded body, and the molten metal is impregnated into the molded body under a state in which the molded body is arranged on the cradle.

In one embodiment, the support surface covers 30% or more of an outer surface of the molded body under a state in which the molded body is arranged on the cradle.

In one embodiment, the molded body has a cylindrical shape.

In one embodiment, the molded body is arranged on the cradle so that an axis of the molded body is parallel to a horizontal direction.

In one embodiment, the support surface has an arc shape. The support surface has a radius of curvature that is ½ or more of an outer diameter of the molded body and ½+0.3 mm or less of the outer diameter of the molded body.

In one embodiment, the supply body is arranged on an inner side of the molded body.

In one embodiment, the support surface has a coating layer formed thereon.

In one embodiment, the support surface has a groove formed therein. The groove forms a gap between the molded body and the cradle under a state in which the molded body is arranged on the cradle.

In one embodiment, the cradle includes a first base having a first surface and a second base having a second surface. The molded body is arranged on the first base and the second base. The first surface and the second surface function as the support surface under a state in which the molded body is arranged on the first base and the second base.

In one embodiment, the deformation suppressing member includes: a first contact portion configured to be brought into contact with the molded body; and a second contact portion, which is located away from the first contact portion in a direction orthogonal to a longitudinal direction of the molded body, and is configured to be brought into contact with the molded body.

In one embodiment, the deformation suppressing member is configured to suppress deformation of a plurality of molded bodies, and the plurality of molded bodies are aligned in a direction orthogonal to longitudinal directions of the plurality of molded bodies and are in contact with each other. The deformation suppressing member includes: a first contact portion configured to be brought into contact with the molded body located at one end of the plurality of molded bodies; and a second contact portion, which is located on an opposite side of the first contact portion with respect to the plurality of molded bodies, and is configured to be brought into contact with the molded body located at another end of the plurality of molded bodies.

In one embodiment, the first contact portion and the second contact portion are configured to be brought into contact with the molded body in a horizontal direction.

In one embodiment, the deformation suppressing member further includes a third contact portion configured to be brought into contact with the molded body in a vertical direction.

In one embodiment, the deformation suppressing member contains at least one kind of material selected from carbon, boron nitride, alumina, or platinum.

In one embodiment, the molded body has a honeycomb structure.

### BRIEF DESCRIPTION OF THE DRAWINGS

FIG. 1 is a schematic perspective view for illustrating a method of manufacturing a Si-SiC-based composite structure according to one embodiment of the present invention.

FIG. 2 is a front view of a cradle in one embodiment of the present invention.

FIG. 3 is a front view of a cradle in another embodiment of the present invention.

FIG. 4 is a front view of a cradle in still another embodiment of the present invention.

FIG. 5A is a front view of a cradle in still another embodiment of the present invention. FIG. 5B is a view for illustrating a mode in which the cradle illustrated in FIG. 5A is formed of a first base and a second base. FIG. 5C is a mode in which the cradle illustrated in FIG. 5A has grooves.

FIG. 6A is a front view of a cradle in still another embodiment of the present invention. FIG. 6B is a view for illustrating a mode in which the cradle illustrated in FIG. 6A is formed of a first base and a second base. FIG. 6C is a mode in which the cradle illustrated in FIG. 6A has grooves.

FIG. 7 is a front view of a honeycomb molded body in one embodiment of the present invention.

FIG. 8 is a view for illustrating a state in which the molded body is accommodated in an accommodation container in one embodiment of the present invention.

FIG. 9 is a view for illustrating a state in which the molded body is accommodated in an accommodation container in another embodiment of the present invention.

FIG. 10 is a view for illustrating a state in which a plurality of molded bodies are accommodated in an accommodation container in still another embodiment of the present invention.

FIG. 11 is a view for illustrating a state in which the molded body is held by a holding member in one embodiment of the present invention.

FIG. 12 is a view for illustrating a state in which an insertion jig in one embodiment of the present invention is inserted in the molded body.

FIG. 13 is a view for illustrating a state in which an insertion jig in another embodiment of the present invention is inserted in the molded body.

FIG. 14 is a view for illustrating a state in which an insertion jig in still another embodiment of the present invention is inserted in the molded body.

FIG. 15 is a view for illustrating a state in which an insertion jig in still another embodiment of the present invention is inserted in the molded body.

FIG. 16 is a view for illustrating a state in which an insertion jig in still another embodiment of the present invention is inserted in the molded body.

FIG. 17A is a view for illustrating a state in which the molded body is supported by a support member in one embodiment of the present invention. FIG. 17B is a side view of the support member illustrated in FIG. 17A.

### DESCRIPTION OF THE EMBODIMENTS

Embodiments of the present invention are described below with reference to the drawings. However, the present invention is not limited to the embodiments.

A. Overview of Method of manufacturing Si-SiC-based Composite Structure

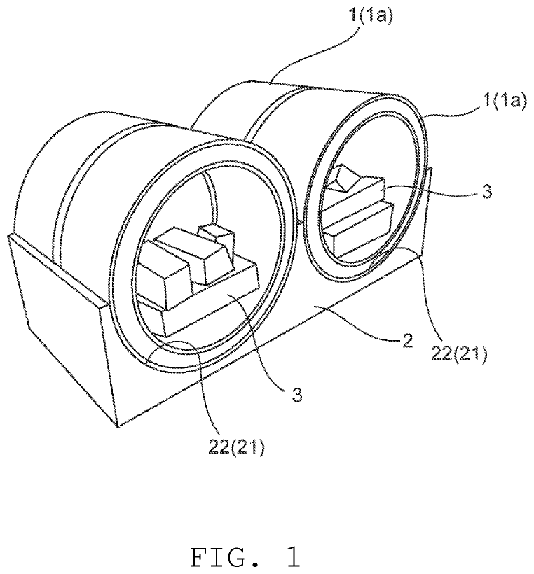

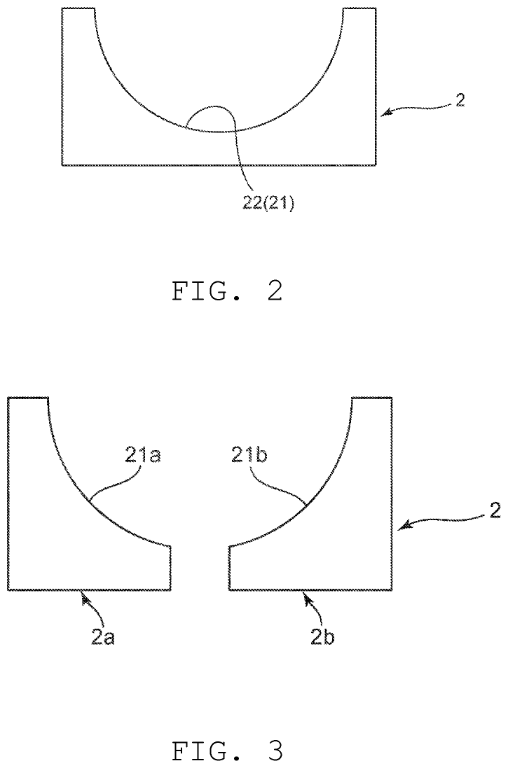

FIG. 1 is a schematic perspective view for illustrating a method of manufacturing a Si-SiC-based composite structure according to one embodiment of the present invention. FIG. 2 is a front view of a cradle in one embodiment of the present invention.

The method of manufacturing a Si-SiC-based composite structure according to one embodiment of the present invention includes a step of impregnating a molten metal containing Si into a molded body 1 containing SiC (impregnation step) by heating a supply body 3 containing Si under a state in which the molded body 1 is in contact with a deformation suppressing member configured to suppress deformation of the molded body 1 and in which the supply body 3 is in contact with the molded body 1.

According to the method described above, the molded body is in contact with the deformation suppressing member, and hence the deformation of the molded body can be suppressed even when the supply body is heated to impregnate a molten metal into the molded body. Thus, a Si-SiC-based composite structure having a desired shape can be manufactured.

In one embodiment, the deformation suppressing member is a cradle 2 having a support surface 21 along an outer shape of the molded body 1. In this case, a molten metal containing Si is impregnated into the molded body 1 under a state in which the molded body 1 is arranged on the cradle 2. The support surface supports the molded body along the outer shape of the molded body under a state in which the molded body is arranged on the cradle 2, and hence the deformation of the molded body can be stably suppressed in the impregnation step.

Under a state in which the molded body 1 is arranged on the cradle 2, the support surface 21 covers preferably 30% or more, more preferably 40% or more of the outer surface of the molded body 1. When the support surface covers the outer surface of the molded body in this manner, the deformation of the molded body in the impregnation step can be stably suppressed. In addition, the upper limit of a range of the outer surface of the molded body 1 covered with the support surface 21 is, for example, 100% or less, preferably 80% or less, more preferably 50% or less. When the ratio of the outer surface of the molded body covered with the support surface is 50% or less, the molded body may be smoothly arranged on the cradle. Under a state in which the molded body 1 is arranged on the cradle 2, the support surface 21 that covers the outer surface of the molded body 1 is in contact with the outer surface of the molded body 1, and more specifically, is in contact with the above-mentioned range of the outer surface of the molded body 1.

The support surface 21 may cover the molded body 1 in its entirety or may include portions that do not cover the molded body 1. In other words, the support surface 21 may be brought into contact with the molded body 1 in its entirety or may include portions that are not brought into contact with the molded body 1.

The molded body 1 may have any appropriate shape depending on the application of the Si-SiC-based composite structure. As the shape of the molded body, there is given, for example, a columnar shape extending in a predetermined direction, and specific examples thereof include a circular columnar shape, an elliptical columnar shape, and a rectangular columnar shape. In addition, the molded body may include a hollow region in a center portion thereof in a cross-section in a direction orthogonal to an axial direction (length direction) of the molded body. That is, the molded body may have, for example, a tubular shape (specifically, a cylindrical shape, an elliptical cylindrical shape, or a rectangular cylindrical shape).

In one embodiment, the molded body 1 has a cylindrical shape. In this case, the support surface 21 of the cradle 2 has an arc surface 22 having an arc shape. The arc surface 22 is recessed downward in a substantially C-shape from an upper surface of the cradle 2. Under a state in which the molded body 1 is arranged on the cradle 2, the arc surface 22 (support surface 21) follows an outer peripheral surface of the molded body 1 and typically covers the above-mentioned range of the outer peripheral surface of the molded body 1.

The radius of curvature of the arc surface 22 is, for example, ½ or more of an outer diameter of the molded body 1 having a cylindrical shape, preferably ½+0.03 mm or more of the outer diameter of the molded body 1, and for example, ½+0.3 mm or less of the outer diameter of the molded body 1, preferably ½+0.15 mm or less of the outer diameter of the molded body 1. When the radius of curvature of the arc surface is equal to or more than the above-mentioned lower limit, the molded body can be smoothly arranged on the cradle, and the breakage of an end portion of the arc surface caused by the contact with the molded body can be suppressed. When the radius of curvature of the arc surface is equal to or less than the above-mentioned upper limit, the support surface can stably support the molded body under a state in which the molded body is arranged on the cradle.

In one embodiment, the molded body 1 is arranged on an upper side of the cradle 2 in a vertical direction. According to such method, the cradle can support the molded body more stably in the impregnation step. In addition, when the molded body 1 has a columnar shape or a tubular shape (typically a cylindrical shape) extending in a predetermined direction, the molded body 1 is preferably arranged on the cradle 2 so that an axis of the molded body 1 is parallel to a horizontal direction. With this configuration, when a plurality of molded bodies are collectively subjected to the impregnation step, the filling efficiency of the molded bodies can be improved, and the manufacturing efficiency of the Si-SiC-based composite structure can be improved.

As illustrated in FIG. 1, the support surface 21 typically extends over the entire cradle 2 in a predetermined direction (width direction of the cradle in FIG. 1). In addition, a plurality of molded bodies 1 may be arranged on one support surface 21. The dimension in the direction in which the support surface 21 extends (axial direction) is, for example, 0.8 time or more, preferably 1.1 times or more with respect to the dimension of the molded body 1 in the axial direction. When the dimension of the support surface in a longitudinal direction is equal to or more than the above-mentioned lower limit, the support surface can support the molded body more stably.

In particular, when the support surface has a length that is 2.1 times or more of the molded body, a plurality of molded bodies may be arranged on one support surface. In FIG. 1, one support surface 21 supports a plurality of (two) molded bodies 1, and the plurality of (two) molded bodies 1 are aligned at a slight interval in a direction in which the support surface 21 extends.

In addition, the cradle 2 may have a plurality of support surfaces 21. In this case, the plurality of support surfaces 21 are arranged at intervals in a direction that intersects (preferably, that is orthogonal to) the direction in which the support surfaces 21 extend. With this configuration, the filling efficiency of the plurality of molded bodies can be further improved in the impregnation step.

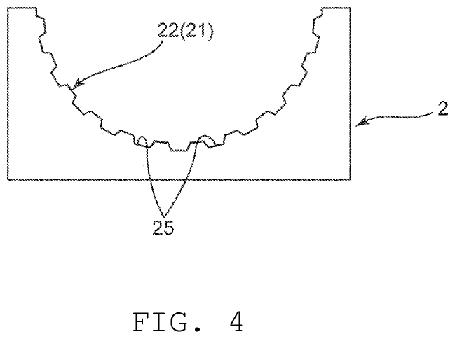

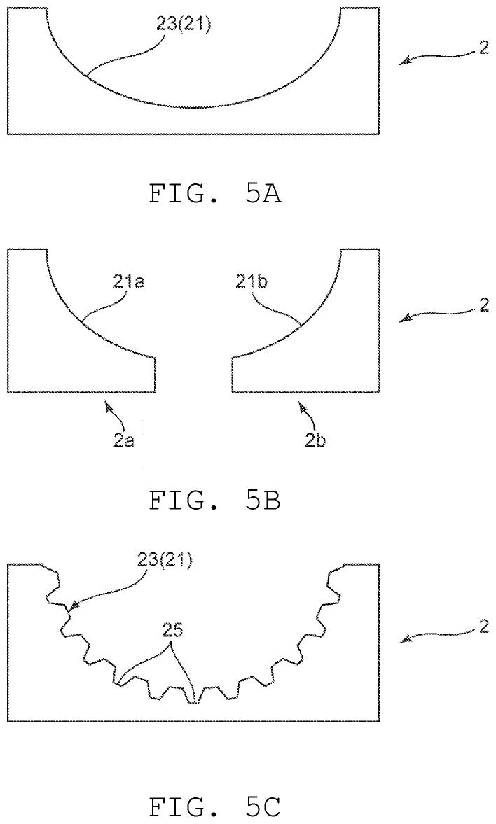

The configuration of the cradle 2 is not particularly limited as long as the cradle 2 can support the molded body 1 as described above in the impregnation step. FIG. 3 is a front view of a cradle (in a mode including a first base and a second base) in another embodiment. FIG. 4 is a front view of a cradle (in a mode in which the support surface has grooves) in still another embodiment.

The cradle 2 illustrated in FIG. 3 includes a first base 2a having a first surface 21a and a second base 2b having a second surface 21b. In the impregnation step, the molded body 1 is arranged on the first base 2a and the second base 2b. The first surface 21a and the second surface 21b function as the support surface 21 (arc surface 22) under a state in which the molded body 1 is arranged on the first base 2a and the second base 2b. Also with this configuration, the deformation of the molded body can be suppressed in the impregnation step, and a Si-SiC-based composite structure having a desired shape can be manufactured. In addition, with this configuration, when only any one of the first base 2a or the second base 2b is broken, only the broken base can be replaced, and thus the running cost may be reduced.

As illustrated in FIG. 4, the support surface 21 (arc surface 22) may have grooves 25 formed therein. The grooves 25 form gaps between the molded body 1 and the cradle 2 under a state in which the molded body 1 is arranged on the cradle 2. Thus, a gas that may be generated in the impregnation step can be smoothly discharged through the gaps. As a result, the degreasing efficiency of the molded body can be improved. A plurality of grooves 25 are preferably formed in the support surface 21. In the illustrated example, the plurality of grooves 25 are formed at intervals in a circumferential direction of the support surface 21 (arc surface 22). With this configuration, under a state in which the molded body 1 is arranged on the cradle 2, portions of the support surface 21 that do not have the grooves 25 are brought into contact with the outer surface of the molded body 1.

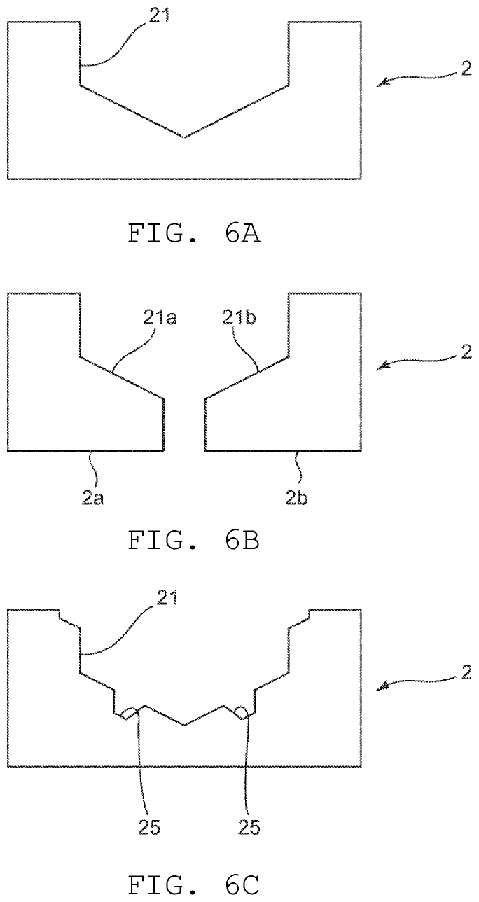

In addition, the support surface 21 may have any appropriate shape depending on the shape of the molded body 1. When the molded body 1 has an elliptical cross-section, the support surface 21 is an oval surface 23 having an oval shape, as illustrated in FIG. 5A. In addition, as illustrated in FIG. 5B, the cradle 2 having the oval surface 23 may also be formed of the first base 2a and the second base 2b as described above, and as illustrated in FIG. 5C, the grooves 25 may also be formed in the oval surface 23 as described above.

In addition, when the molded body 1 has a polygonal cross-section, the support surface 21 may be formed of a plurality of flat surfaces, as illustrated in FIG. 6A. The number of the flat surfaces may be set suitably depending on the shape of the molded body. In addition, as illustrated in FIG. 6B, the cradle 2 having the support surface 21 formed of a plurality of flat surfaces may also be formed of the first base 2a and the second base 2b as described above, and as illustrated in FIG. 6C, the grooves 25 may also be formed in the support surface 21 formed of a plurality of flat surfaces.

In one embodiment, one end portion of the support surface 21 (example of a first contact portion) and another end portion thereof (example of a second contact portion) sandwich the molded body 1 in the horizontal direction orthogonal to the longitudinal direction of the molded body 1 and are in contact with the molded body 1. With this configuration, the expansion of the molded body 1 in the horizontal direction can be suppressed in the impregnation step.

The configuration of the deformation suppressing member is not limited to the cradle 2 as long as the deformation suppressing member can suppress the deformation of the molded body 1 in the impregnation step.

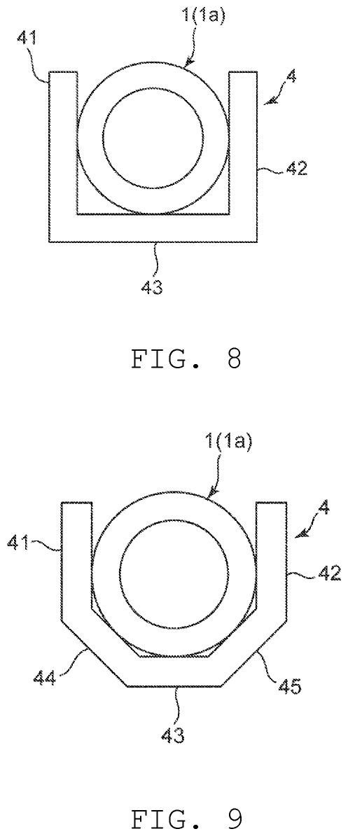

As illustrated in FIG. 8 to FIG. 10, the deformation suppressing member may be an accommodation container 4 capable of accommodating the molded body. As illustrated in FIG. 8, the accommodation container 4 includes a first side wall 41 as an example of the first contact portion and a second side wall 42 as an example of the second contact portion. The first side wall 41 is brought into contact with the molded body 1 under a state in which the accommodation container 4 accommodates the molded body 1. The second side wall 42 is located away from the first side wall 41 in a direction orthogonal to the longitudinal direction of the molded body 1 and is brought into contact with the molded body 1 under a state in which the accommodation container 4 accommodates the molded body 1. In one embodiment, the first side wall 41 and the second side wall 42 extend along the vertical direction and are brought into contact with the molded body 1 in the horizontal direction. With this configuration, the expansion of the molded body in a direction orthogonal to the longitudinal direction (typically the horizontal direction) can be suppressed in the impregnation step. In one embodiment, the accommodation container 4 further includes a bottom wall 43 as an example of a third contact portion. The bottom wall 43 is located below the molded body 1 accommodated in the accommodation container 4 and is brought into contact with the molded body 1 in the vertical direction. As a result, the expansion in the vertical direction of the molded body in the impregnation step can be suppressed. The bottom wall 43 typically extends along the horizontal direction and connects a lower end portion of the first side wall 41 and a lower end portion of the second side wall 42 to each other. For this reason, the accommodation container 4 illustrated in FIG. 8 has a substantially U-shape that is opened upward and is in contact with one molded body 1 in three portions.

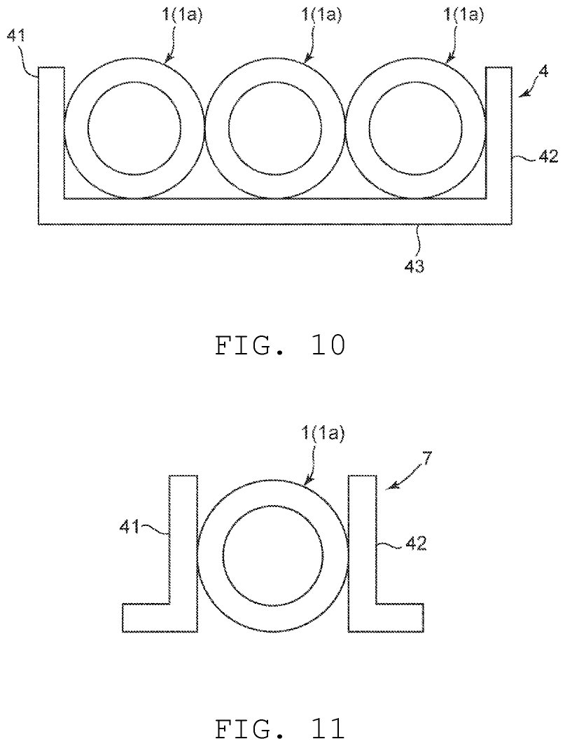

As illustrated in FIG. 9, the number of contact portions of the accommodation container 4 with the molded body 1 may be three or more. In one embodiment, the accommodation container 4 further includes two connecting walls 44 and 45 in addition to the first side wall 41, the second side wall 42, and the bottom wall 43. Under a state in which the accommodation container 4 accommodates the molded body 1, the two connecting walls 44 and 45 are brought into contact with the molded body 1. Each of the connecting walls 44 and 45 typically extends so as to intersect both the vertical and horizontal directions. The connecting wall 44 connects the lower end portion of the first side wall 41 and one end portion of the bottom wall 43 in a width direction to each other. The connecting wall 45 connects the lower end portion of the second side wall 42 and another end portion of the bottom wall 43 in the width direction to each other.

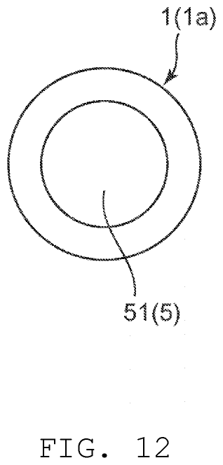

As illustrated in FIG. 10, in one embodiment, the accommodation container 4 can accommodate a plurality of molded bodies 1 aligned in the direction orthogonal to the longitudinal direction of the molded bodies 1 (typically the horizontal direction). The plurality of molded bodies 1 are in contact with each other under a state of being accommodated in the accommodation container 4. In this case, the first side wall 41 is brought into contact with the molded body 1, of the plurality of molded bodies 1, which is located at one end in the direction in which the molded bodies are aligned. The second side wall 42 is located on an opposite side of the first side wall 41 with respect to the plurality of molded bodies 1. The second side wall 42 is brought into contact with the molded body 1, of the plurality of molded bodies 1, which is located at another end in the direction in which the molded bodies are aligned. Each of the first side wall 41 and the second side wall 42 is typically brought into contact with the corresponding molded body 1 in the horizontal direction. The bottom wall 43 is typically located below the plurality of molded bodies 1 accommodated in the accommodation container 4 and is brought into contact with the plurality of molded bodies 1 collectively in the vertical direction. With this configuration, the accommodation container 4 can suppress the deformation of the plurality of molded bodies 1 collectively in the impregnation step.

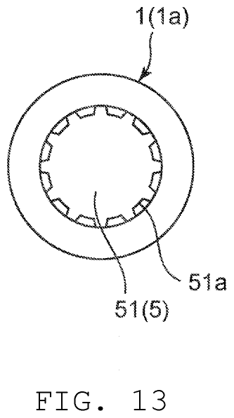

The accommodation container 4 described above includes the first side wall 41 and the second side wall 42 connected to each other and can accommodate the molded body 1. However, as illustrated in FIG. 11, the deformation suppressing member may be a holding member 7 including the first side wall 41 and the second side wall 42 as separate parts. The holding member 7 can hold the molded body 1 in the direction orthogonal to the longitudinal direction (typically the horizontal direction) with the first side wall 41 and the second side wall 42. Also with this configuration, the deformation of the molded body in the impregnation step can be suppressed.

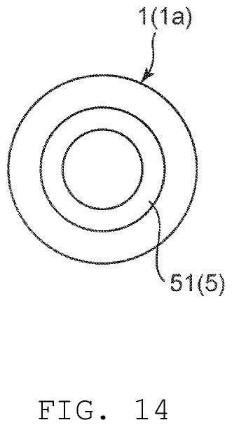

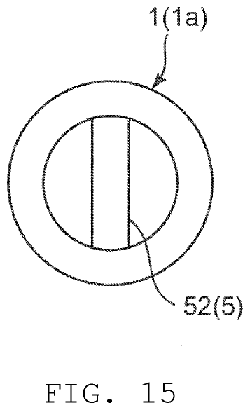

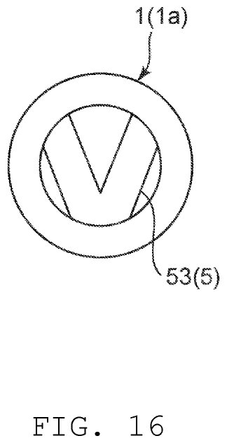

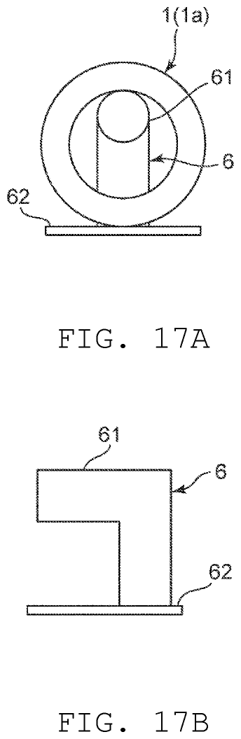

When the molded body 1 has a tubular shape (specifically, a cylindrical shape, an elliptical cylindrical shape, or a rectangular cylindrical shape), the deformation suppressing member may be an insertion jig 5 that is inserted in an inner space of the molded body 1, as illustrated in FIG. 12 to FIG. 16. In an insertion jig 51 illustrated in FIG. 12, an entire outer surface (outer peripheral surface) of the insertion jig 51 is in contact with an inner surface (inner peripheral surface) of the molded body 1 under a state of being inserted in the molded body 1. Grooves 51a may be formed in the outer surface of the insertion jig 51 as illustrated in FIG. 13. The grooves 51a form gaps between the insertion jig 51 and the molded body 1 under a state in which the insertion jig 51 is inserted in the molded body 1. Thus, a gas that may be generated in the impregnation step can be smoothly discharged through the gaps. A plurality of grooves 51a are preferably formed at predetermined intervals on the outer surface of the insertion jig 51. In addition, as illustrated in FIG. 14, the insertion jig 51 may include a hollow region in a center portion thereof in a cross-section in the direction orthogonal to the longitudinal direction. In addition, as long as the insertion jig 5 is brought into contact with the inner surface (inner peripheral surface) of the molded body 1 in at least two portions, the deformation of the molded body 1 in the impregnation step may be suppressed. As illustrated in FIG. 15, the insertion jig 52 is in contact with the inner surface (inner peripheral surface) of the molded body 1 in two portions under a state of being inserted in the molded body 1. The insertion jig 52 typically has a substantially I-shape when viewed from the longitudinal direction of the molded body. In addition, as illustrated in FIG. 16, an insertion jig 53 is in contact with the inner surface (inner peripheral surface) of the molded body 1 in three portions under a state of being inserted in the molded body 1. The insertion jig 53 typically has a substantially V-shape when viewed from the longitudinal direction of the molded body.

In addition, when the molded body 1 has a tubular shape (specifically, a cylindrical shape, an elliptical cylindrical shape, or a rectangular cylindrical shape), the deformation suppressing member may be a support member 6 that supports the molded body so that the molded body is suspended, as illustrated in FIG. 17A and FIG. 17B. The support member 6 includes a hook portion 61 as an example of the first contact portion and a support plate 62 as an example of the second contact portion. The hook portion 61 typically has a substantially L-shape in side view. The hook portion 61 continuously extends upward from the support plate 62 and is bent to extend in the horizontal direction. The support plate 62 typically has a flat plate shape extending in the horizontal direction. Under a state in which the support member 6 supports the molded body 1, a part of the hook portion 61 extending in the horizontal direction is inserted in the inner space of the molded body 1 and is brought into contact with the inner surface (inner peripheral surface) of the molded body 1 in the vertical direction. Under a state in which the support member 6 supports the molded body 1, the support plate 62 is located away in the vertical direction from the part of the hook portion 61 extending in the horizontal direction and is brought into contact with an outer surface (outer peripheral surface) of the molded body 1 in the vertical direction. Also with this configuration, the deformation of the molded body in the impregnation step can be suppressed.

The details of the molded body, the supply body, and the cradle in a method of manufacturing a Si-SiC-based composite structure are described below, and then the detail of the impregnation step is described below.

B. Molded Body

The molded body is a body to be impregnated into which the molten metal containing Si is impregnated in the impregnation step. The molded body contains SiC as a main component as described above. For example, the term “SiC” as used herein is intended to encompass SiC containing unavoidable impurities as well as pure SiC. The constituent materials for the molded body may also contain Al and/or Si in addition to SiC. The content ratio of SiC in the molded body is, for example, 50 mass % or more, preferably 85 mass % or more, and is, for example, 100 mass % or less, preferably 95 mass % or less.

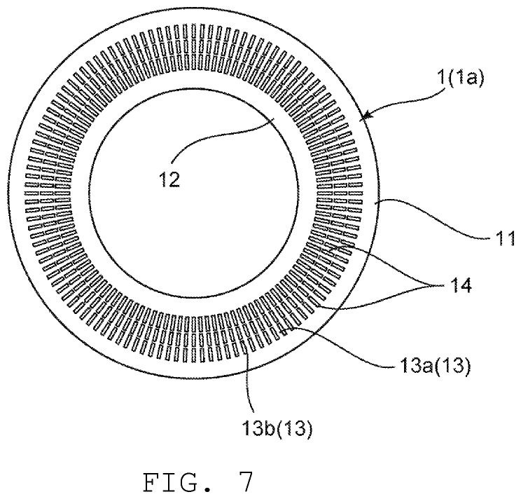

In one embodiment, as illustrated in FIG. 7, the molded body 1 is a honeycomb molded body 1a having a honeycomb structure. When the molded body is a honeycomb molded body, the Si-SiC-based composite structure may be a honeycomb structure. The honeycomb molded body 1a has a plurality of cells 14. The cells 14 extend from a first end surface to a second end surface of the honeycomb molded body 1a in an axial direction (length direction) of the honeycomb molded body 1a. The cells 14 each have any appropriate shape in a cross-section in a direction orthogonal to the axial direction of the honeycomb molded body 1a. As the sectional shape of each of the cells, there are given, for example, a triangular shape, a quadrangular shape, a pentagonal shape, and a polygonal shape of a hexagonal shape or more. All of the cells may be the same in sectional shape and size, or at least some of the cells may be different in sectional shape and size.

The honeycomb molded body 1a has a circular columnar shape and includes a hollow region in a center portion thereof. The outer diameter of the honeycomb molded body may be appropriately set depending on the purpose. The outer diameter of the honeycomb molded body may be, for example, from 20 mm to 200 mm, and for example, from 30 mm to 100 mm. When the sectional shape of the honeycomb molded body is not a circular shape, the diameter of a maximum inscribed circle inscribed in the sectional shape (e.g., a polygonal shape) of the honeycomb molded body may be defined as the outer diameter of the honeycomb structure. The length of the honeycomb molded body may be appropriately set depending on the purpose. The length of the honeycomb molded body may be, for example, from 3 mm to 200 mm, for example, from 5 mm to 100 mm, and for example, from 10 mm to 50 mm.

The honeycomb molded body 1a includes: an outer peripheral wall 11; an inner peripheral wall 12 located on an inner side of the outer peripheral wall 11; and partition walls 13 located between the outer peripheral wall 11 and the inner peripheral wall 12.

The outer peripheral wall 11 has a cylindrical shape. An outer surface of the honeycomb molded body 1a refers to an outer peripheral surface of the outer peripheral wall 11. The inner peripheral wall 12 has a cylindrical shape having a diameter smaller than that of the outer peripheral wall 11. The outer peripheral wall 11 and the inner peripheral wall 12 have an axis in common. Each of the thicknesses of the outer peripheral wall 11 and the inner peripheral wall 12 may be appropriately set depending on the application of the honeycomb structure. Each of the thicknesses of the outer peripheral wall 11 and the inner peripheral wall 12 may be, for example, from 0.3 mm to 10 mm, and may be, for example, from 0.5 mm to 5 mm. When the thicknesses of the outer peripheral wall and/or the inner peripheral wall fall within such ranges, the fracture (e.g., flaws and cracks) of the wall caused by an external force can be suppressed.

The partition walls 13 define a plurality of cells 14. More specifically, the partition walls 13 each have a first partition wall 13a extending in a radiation direction from the inner peripheral wall 12 to the outer peripheral wall 11 and a second partition wall 13b extending in a circumferential direction, and the first partition walls 13a and the second partition walls 13b define the plurality of cells 14. The sectional shape of each of the cells 14 is a quadrangular shape (rectangle that is elongated in a radial direction of the honeycomb molded body). With this configuration, the honeycomb molded body is liable to be deformed in the impregnation step. However, the honeycomb molded body is arranged on the cradle in the impregnation step, and hence the deformation of the honeycomb molded body can be suppressed even when the honeycomb molded body has cells each extending radially.

In addition, although not shown, the first partition walls 13a and the second partition walls 13b are orthogonal to each other and may define the cells 14 each having a sectional shape of a quadrangular shape (square shape) except for portions in which the first partition walls 13a and the second partition walls 13b are in contact with the inner peripheral wall 12 and the outer peripheral wall 11.

The cell density (i.e., the number of the cells 14 per unit area) in the cross-section in the direction orthogonal to the axial direction of the honeycomb molded body may be appropriately set depending on the purpose. The cell density may be, for example, from 4 cells/cm² to 320 cells/cm². When the cell density falls within such range, the strength and effective geometric surface area (GSA) of the honeycomb structure can be sufficiently ensured.

The thickness of each of the partition walls 13 may be appropriately set depending on the application of the honeycomb structure. The thickness of each of the partition walls 13 is typically smaller than the thickness of each of the outer peripheral wall 11 and the inner peripheral wall 12. The thickness of each of the partition walls 13 may be, for example, from 0.1 mm to 1.0 mm, or, for example, from 0.2 mm to 0.6 mm. When the thickness of each of the partition walls falls within such range, the honeycomb structure having sufficient mechanical strength can be obtained. In addition, a sufficient opening area (total area of the cells in the cross section) can be obtained.

The porosity in each of the outer peripheral wall 11, the inner peripheral wall 12, and the partition walls 13 may be appropriately set depending on the purpose. The porosity thereof is, for example, 15% or more, preferably 20% or more, and is, for example, 50% or less, preferably 45% or less. The porosity may be measured, for example, by mercury porosimetry. When the porosity in the outer peripheral wall, the inner peripheral wall, and the partition walls falls within such ranges, a molten metal can be impregnated into the honeycomb molded body through use of a capillary force in an impregnation step.

The density (density of molded body) in each of the outer peripheral wall 11, the inner peripheral wall 12, and the partition walls 13 may be appropriately set depending on the purpose. The density thereof is, for example, 1.7 g/cm³ or more, preferably 1.8 g/cm³ or more, and is, for example, 2.8 g/cm³ or less, preferably 2.6 g/cm³ or less. The density may be measured, for example, by mercury porosimetry. When the density of each of the outer peripheral wall, the inner peripheral wall, and the partition walls falls within such ranges, voids can be formed inside the outer peripheral wall, the inner peripheral wall, and the partition walls with the porosity described above.

Such molded body (honeycomb molded body) may be produced by the following method. First, a binder, water, or an organic solvent are added to inorganic material powder including SiC powder, and the resultant mixture is kneaded to form a plastic matter. The plastic matter is molded (typically extrusion-molded) into a desired shape and dried to produce a dry body (honeycomb dry body). Next, the dry body (honeycomb dry body) is subjected to predetermined outer shape processing, and thus a molded body (honeycomb molded body) having a desired shape can be obtained.

C. Supply Body

The supply body contains Si as a main component as described above. The constituent materials for the supply body may also contain Al in addition to Si. The content ratio of Si in the supply body is, for example, 50 mass % or more, preferably 90 mass % or more, more preferably 95 mass % or more, and is, for example, 100 mass % or less, preferably 97 mass % or less, more preferably 96 mass % or less. When the content ratio of Si in the supply body falls within such ranges, the molten metal containing Si can be uniformly impregnated into the entire molded body in the impregnation step, and the impregnation amount of Si in the Si-SiC-based composite structure can be made uniform.

The supply body may have any appropriate shape and size as long as the supply body can be brought into contact with the molded body in the impregnation step.

Such supply body may be obtained, for example, by forming inorganic material powder containing Si powder into a desired shape (typically by press forming) and then drying the resultant.

D. Deformation Suppressing Member (Cradle)

The deformation suppressing member is typically formed of a material that is stable at a heating temperature in the impregnation step. The deformation suppressing member (typically a cradle) preferably contains at least one kind of material selected from carbon, boron nitride, alumina, or platinum.

A coating layer is preferably formed on a contact surface (typically the support surface of the cradle) of the deformation suppressing member with the molded body. When the coating layer is formed on the support surface, the coating layer is brought into contact with the outer surface of the molded body under a state in which the molded body is arranged on the cradle. The coating layer suppresses the soaking of a molten metal containing Si into the deformation suppressing member (typically the cradle) in the impregnation step. As a material for the coating layer, there are given preferably materials that are inactive to (materials that have no reactivity with) each of the materials for the deformation suppressing member (typically the cradle), the molded body, and the molten metal, more preferably boron nitride. The coating layer has a thickness of, for example, 0.01 mm or more and 0.15 mm or less.

Such deformation suppressing member (cradle) may be obtained, for example, by cutting processing. After that, as required, a coating layer is formed on the support surface by spraying boron nitride.

E. Impregnation Step

In the impregnation step, first, the molded body (honeycomb molded body) is brought into contact with the deformation suppressing member as described above. After that, the supply body is brought into contact with the molded body under a state of being in contact with the deformation suppressing member.

The supply body may be arranged at any appropriate position as long as the supply body can be brought into contact with the molded body in the impregnation step. For example, as illustrated in FIG. 1, when the molded body 1 has a tubular shape (typically, a cylindrical shape), the supply body 3 is arranged on the inner side of the molded body 1 and is brought into contact with the inner peripheral surface (inner surface) of the molded body 1. In this case, the hollow region of the molded body can be utilized as an arrangement space for the supply body, and hence the filling efficiency of the molded body may be further improved. In addition, as illustrated in FIG. 12, when the jig is inserted in the inner side of the molded body 1, the supply body is arranged on the outer side of the molded body and is brought into contact with the outer peripheral surface (outer surface) of the molded body.

The usage amount of the supply body is, for example, 20 parts by mass or more, preferably 30 parts by mass or more, and for example, 80 parts by mass or less, preferably 70 parts by mass or less with respect to 100 parts by mass of the molded body. When the usage amount of the supply body is equal to or more than the above-mentioned lower limit, Si can be sufficiently impregnated into the molded body. When the usage amount of the supply body is equal to or less than the above-mentioned upper limit, the excess influence of a load of the supply body on the molded body can be suppressed, and the leakage of the molten metal from the molded body can be suppressed.

Next, the molded body, the supply body, and the deformation suppressing member are collectively heated.

The heating temperature is, for example, 1,200° C. or more, preferably 1,300° C. or more, and is, for example, 1,600° C. or less, preferably 1,500° C. or less. The heating time is, for example, 10 minutes or more, preferably 1 hour or more. When the heating temperature falls within the above-mentioned ranges, and/or the heating time is equal to or more than the above-mentioned lower limit, the molten metal containing Si can be smoothly impregnated into the molded body. The upper limit of the heating time is typically 10 hours or less, preferably 5 hours or less. When the heating time is equal to lower than the above-mentioned upper limit, the manufacturing efficiency of the Si-SiC-based composite structure can be further improved.

Further, the impregnation step is performed preferably under reduced pressure. When the impregnation step is performed under reduced pressure, the molten metal containing Si can be further smoothly impregnated into the molded body. The pressure in the impregnation step is, for example, 500 Pa or less, preferably 300 Pa or less, more preferably 200 Pa or less, and is typically 10 Pa or more. The impregnation step may also be performed under normal pressure (0.1 MPa).

With this configuration, the molten metal containing Si is impregnated into the molded body while the deformation of the molded body is suppressed. As a result, a Si-SiC-based composite structure (honeycomb structure) having a desired shape can be manufactured.

The method of manufacturing a Si-SiC-based composite structure according to at least one embodiment of the present invention is used in manufacturing of various industrial products, and may be suitably used, in particular, in manufacturing of a heat exchanger.

According to the at least one embodiment of the present invention, the Si-SiC-based composite structure having a desired shape can be manufactured while suppressing the deformation of the molded body.

What is claimed is:

1. A method of manufacturing a Si-SiC-based composite structure, comprising a step of impregnating a molten metal containing Si into a molded body containing SiC by heating a supply body containing Si under a state in which the molded body is in contact with a deformation suppressing member configured to suppress deformation of the molded body and in which the supply body is in contact with the molded body.

2. The method of manufacturing a Si-SiC-based composite structure according to claim 1,
wherein the deformation suppressing member is a cradle having a support surface along an outer shape of the molded body, and
wherein the molten metal is impregnated into the molded body under a state in which the molded body is arranged on the cradle.

3. The method of manufacturing a Si-SiC-based composite structure according to claim 2, wherein the support surface covers 30% or more of an outer surface of the molded body under a state in which the molded body is arranged on the cradle.

4. The method of manufacturing a Si-SiC-based composite structure according to claim 2, wherein the molded body has a cylindrical shape.

5. The method of manufacturing a Si-SiC-based composite structure according to claim 4, wherein the molded body is arranged on the cradle so that an axis of the molded body is parallel to a horizontal direction.

6. The method of manufacturing a Si-SiC-based composite structure according to claim 4,
wherein the support surface has an arc shape, and
wherein the support surface has a radius of curvature that is ½ or more of an outer diameter of the molded body and ½+0.3 mm or less of the outer diameter of the molded body.

7. The method of manufacturing a Si-SiC-based composite structure according to claim 4, wherein the supply body is arranged on an inner side of the molded body.

8. The method of manufacturing a Si-SiC-based composite structure according to claim 2, wherein the support surface has a coating layer formed thereon.

9. The method of manufacturing a Si-SiC-based composite structure according to claim 2,
wherein the support surface has a groove formed therein, and
wherein the groove forms a gap between the molded body and the cradle under a state in which the molded body is arranged on the cradle.

10. The method of manufacturing a Si-SiC-based composite structure according to claim 2,
wherein the cradle includes a first base having a first surface and a second base having a second surface,
wherein the molded body is arranged on the first base and the second base, and
wherein the first surface and the second surface function as the support surface under a state in which the molded body is arranged on the first base and the second base.

11. The method of manufacturing a Si-SiC-based composite structure according to claim 1,
wherein the deformation suppressing member includes:
a first contact portion configured to be brought into contact with the molded body; and
a second contact portion, which is located away from the first contact portion in a direction orthogonal to a longitudinal direction of the molded body, and is configured to be brought into contact with the molded body.

12. The method of manufacturing a Si-SiC-based composite structure according to claim 1,
wherein the deformation suppressing member is configured to suppress deformation of a plurality of molded bodies,
wherein the plurality of molded bodies are aligned in a direction orthogonal to longitudinal directions of the plurality of molded bodies and are in contact with each other, and
wherein the deformation suppressing member includes:
a first contact portion configured to be brought into contact with the molded body located at one end of the plurality of molded bodies; and
a second contact portion, which is located on an opposite side of the first contact portion with respect to the plurality of molded bodies, and is configured to be brought into contact with the molded body located at another end of the plurality of molded bodies.

13. The method of manufacturing a Si-SiC-based composite structure according to claim 11, wherein the first contact portion and the second contact portion are configured to be brought into contact with the molded body in a horizontal direction.

14. The method of manufacturing a Si-SiC-based composite structure according to claim 13, wherein the deformation suppressing member includes a third contact portion configured to be brought into contact with the molded body in a vertical direction.

15. The method of manufacturing a Si-SiC-based composite structure according to claim 1, wherein the deformation suppressing member contains at least one kind of material selected from carbon, boron nitride, alumina, or platinum.

16. The method of manufacturing a Si-SiC-based composite structure according to claim 1, wherein the molded body has a honeycomb structure.

17. A method of manufacturing a Si-SiC-based composite structure, comprising a step of impregnating a molten metal containing Si into a molded body containing SiC by heating a supply body containing Si under a state in which the molded body is in contact with a deformation suppressing member configured to suppress deformation of the molded body and in which the supply body is in contact with the molded body,
wherein the deformation suppressing member is a cradle having a support surface along an outer shape of the molded body,
wherein the molten metal is impregnated into the molded body under a state in which the molded body is arranged on the cradle,
wherein the support surface covers 30% or more of an outer surface of the molded body under a state in which the molded body is arranged on the cradle,
wherein the molded body has a cylindrical shape,
wherein the molded body is arranged on the cradle so that an axis of the molded body is parallel to a horizontal direction,
wherein the support surface has an arc shape,
wherein the support surface has a radius of curvature that is ½ or more of an outer diameter of the molded body and ½+0.3 mm or less of the outer diameter of the molded body,
wherein the supply body is arranged on an inner side of the molded body,
wherein the support surface has a coating layer formed thereon,
wherein the support surface has a groove formed therein,
wherein the groove forms a gap between the molded body and the cradle under a state in which the molded body is arranged on the cradle,
wherein the deformation suppressing member includes:
a first contact portion configured to be brought into contact with the molded body; and
a second contact portion, which is located away from the first contact portion in a direction orthogonal to a longitudinal direction of the molded body, and is configured to be brought into contact with the molded body,
wherein the first contact portion and the second contact portion are configured to be brought into contact with the molded body in a horizontal direction,
wherein the deformation suppressing member contains at least one kind of material selected from carbon, boron nitride, alumina, or platinum, and
wherein the molded body has a honeycomb structure.
